(19) United States
(12) Patent Application Publication
(10) Pub. No.: US 2005/0171798 A1
(43) Pub. Date: Aug. 4, 2005

(54) Method and system for minimizing the risk of leasing trucks

(76) Inventors: Michael Shane Croft, Orlando, FL (US); Phillip S. Hofmann, Longwood, FL (US)

Correspondence Address: Howard M. Gitten;Edwards & Angell, LLP, P.O. Box 55874, Boston, MA, 02205, US

(21) Appl. No.: 10/773,081

(22) Filed: Feb. 4, 2004

(51) Int. Cl. G06F 17/60

(52) U.S. Cl. 705/1

(57) ABSTRACT

A method for reducing the risk of leasing class 8 trucks to individuals by making the truck seller guarantee a lessee for a particular truck for a predetermined period. The buyer then buys the truck from the seller and leases the truck to the lessee.

### BACKGROUND OF THE INVENTION

1. Field of Invention

The present invention is directed to a method of doing business and system for minimizing the risk of financing trucks, and more particularly, to a method and system for reducing the risk of leasing trucks to a class of individuals for whom leasing trucks was not an option.

2. Background

Since the advent of trucks, there have been mechanisms for financing the sales of trucks to individuals. However, as trucks such as class 8 trucks became more sophisticated and larger, they became ever more expensive, making the periodic payments due to a financing company such as a bank ever more expensive. Furthermore, as the finance payments became larger, the requirements to prove creditworthiness to a bank became stricter and stricter so that individuals were in effect squeezed out of the market for purchasing vehicles as such decisions are made primarily on current income and assets. Most individuals seeking to purchase their first truck do not have the necessary income or assets to qualify for such loans.

Leasing vehicles has been adopted as a financing strategy in the truck industry as a way of reducing the cost to the lessee to take possession of the truck. It is well known in the art to lease vehicles such as class 8 (commonly known as “18-wheelers”) and other types of tractor trucks for use in combination with a trailer. Traditionally, ownership of the vehicle such as a class 8 truck remains with one entity, either a bank, financing company or dealership. The lease requires periodic payments over a finite period of time. At the end of the lease the vehicle is returned to the possession of the owner.

The periodic lease payments are a function of the initial value of the vehicle to be leased, the estimated end value of the vehicle to be leased and the amount of use of the vehicle over time. Therefore, the higher the initial value of the vehicle and the lower the ending value of the vehicle and the greater the use of the vehicle the higher the periodic payments. With regard to class 8 trucks, those which haul freight, the initial value of the truck can be quite high. Furthermore, because this class of trucks is traditionally the long haul trucks, the use of the trucks is quite great. As a result, the periodic payments are quite high.

This method of operation has been satisfactory to date, however, it also suffers from the disadvantage that it unintentionally systematically makes leasing of a class 8 or other similarly expensive vehicles extremely difficult for individual owner operators. In effect, the owner of the truck is financing the lease arrangement on the expected return of the lease payments. Where the owner of the truck perceives high risk, they will not lease the truck. Currently, financing agencies perceive risk as a function of income and assets.

Individuals and small business operators who wish to lease trucks often do not qualify for this type of traditional financing because when first opening their independent small business, the truck to be leased may represent the only asset of the company. Furthermore, small businessmen do not possess the liquidity for the high down payments required by traditional finance companies to either lease or buy the vehicle. The small businessmen have little or no credit histories, or may have one or two unfavorable credit occurrences in their past. These vehicles cost more than $100,000 to purchase, and even as much as $30,000 to $50,000 used. Furthermore, retail truck dealers are unable to secure financing for individuals in these categories and turn away over 50% of those truckers who apply for financing. As a result, retail dealers who can neither sell nor lease vehicles to more than 50% of the potential market, are left with a growing fleet of vehicles they cannot dispose of.

Accordingly, it is desired to provide a system and method for making class 8 trucks available for lease to independent truckers and small business owners.

### SUMMARY OF THE INVENTION

In accordance with the present invention, a method of reducing the risk of leasing a class 8 truck includes obtaining a purchase contract for a class 8 truck in which a condition of the purchase is that the seller of the vehicle guarantees a lessee for the truck for a predetermined period and then leasing the truck to the lessee obtained by the owner of the truck.

In one embodiment of the invention, the lessee must also make a non-refundable, up front lease fee and the lease is a commercial operating lease. Furthermore, the lease payments are made weekly. Lastly, each leased truck is provided with a global positioning system (GPS) for tracking the vehicle if the lease goes into default.

Furthermore, in accordance with the present invention, a method for reducing the risk for leasing a truck, comprises the steps of storing at least one computer data file in a computer database reflecting the terms of the purchase agreement between the buyer and the seller, the terms including at least a guarantee from the seller of a lessee and the identity of that lessee including a bank account and lease terms, said computer automatically, on a periodic basis deducting the payment from a bank account owned by lessee.

### BRIEF DESCRIPTION OF THE DRAWINGS

In the drawing figures, which are not to scale and which are merely illustrated, and wherein like reference numerals depict like elements throughout the several views:

FIG. 1 is a timeline for executing the invention in accordance with the present invention;

FIG. 2 is a flowchart for minimizing the risk of financing a class 8 truck in accordance with the invention;

FIG. 3 is a computer system in accordance with the invention; and

FIG. 4 is a flowchart for performing the method on the system in accordance with the invention.

### DETAILED DESCRIPTION OF THE INVENTION

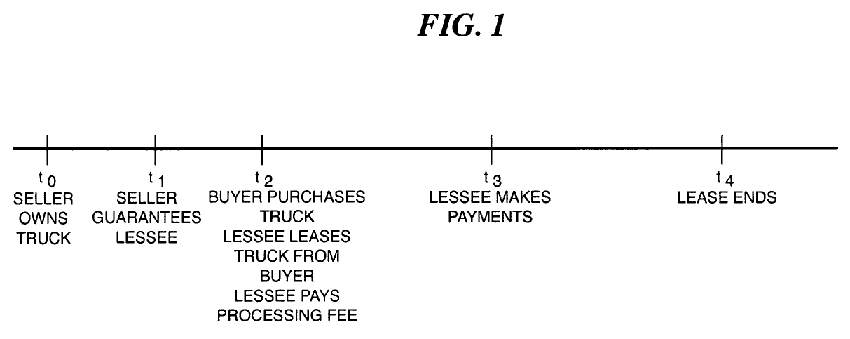

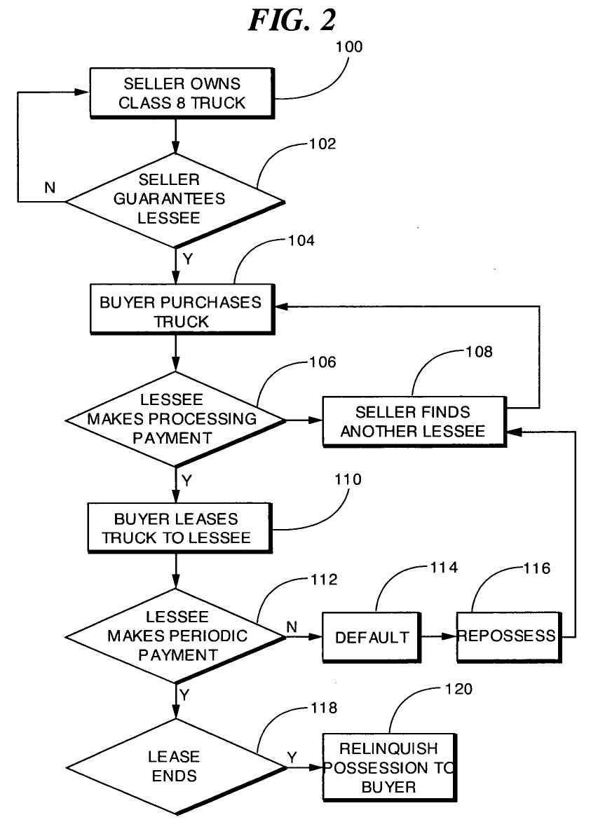

Reference is made to FIGS. 1 and 2, wherein a timeline and an algorithm of the method for reducing the lease risk is provided. At an initial time to a seller owns a class 8 truck in a step 100. In a preferred embodiment, the seller is a retailer of trucks such as at a truck dealership, or perhaps at a truck auction or the like. In a preferred embodiment, the seller is the owner of multiple class 8 trucks so that the seller is incentivized to reduce their fleet and the associated carrying costs thereof. At a time t₁, which is any time subsequent to time to, in a step 102, it is determined whether the seller will guarantee that it will obtain a lessee for a buyer of a particular truck owned by the seller. If the seller will not guarantee a lessor, then the process is returned to step 100.

In step 102, the seller guarantees that it will obtain a lessee for a particular truck for a predetermined time period. This time period is usually at least equivalent to a minimum industry standard lease of class 8 trucks. The guarantee would not be that the seller would obtain a single lessee, or a particular lessee, who will lease the truck for the given period, although the invention could be performed that way, but in a preferred embodiment what is guaranteed is that during the predetermined period, seller will always provide a willing and able lessee for that particular truck. The guarantee may be oral or may become part of the sales contract and in one example may read as follows:
Seller guarantees that for a period of 48 months from sale that seller shall provide a qualified lessee of the Vehicle to buyer.
If lessee shall breach the Lease, then seller shall be responsible for the terms of the lease until a qualified Lessee has executed a Lease for the Vehicle.

Upon execution of the agreement containing the guarantee at t₂, the buyer has purchased the class 8 vehicle.

Between t₁ and t₂, the owner will identify a lessee to buyer. As part of the method in a preferred embodiment, it has been determined that current income and assets, although a factor, are not the most significant indicator of likelihood of any lessee defaulting on a lease. As part of the novel method a questionnaire has been developed for qualifying lessees to be utilized by the truck owner in step 102 to guarantee the lessee. The questionnaire includes personal information and business information. Personal information, by way of example, includes date of birth, social security number, commercial driver's license, marital status and identity of spouse, previous marriages and identities of previous spouses, family information such as children and dependents, parents, brothers and sisters, education levels, military history including discharge and court martial, arrests, detentions, and litigations in which the lessee has been involved, residence information for the past ten years, as well as employment information such as the identity of previous employers as well as the names of supervisors, character references and other licenses. Business information, by way of example, would be current employer or ownership interest in any other companies, as well as the equipment to be leased and other equipment which is either currently or previously owned and/or leased as well as the past year's gross annual income. It has been determined that social and criminal history is a greater indicator of the likelihood of defaulting on the lease than pure economic information, previously relied upon by prior art leasing methods.

It has also been determined that the ability to pay an initial, non-refundable processing fee reduces the likelihood and risk of defaulting on the lease. Therefore, in a step 106, at t₂, the lessee is required to make such a non-refundable payment. In a preferred embodiment, this payment is not applied against any of the periodic lease payments due, however it is contemplated in some instances that at least a portion of this payment may be used as a credit against other payments due. Furthermore, it has been determined that the payment should be between about $3,000 and $10,000 and more particularly, about $3,900. It has been determined that if the fee is $3,900 the likelihood of defaulting goes down significantly as compared to payments of $3,500 and less and does not go down significantly as compared to $4,000 or payments as high as $10,000. Therefore, in step 106 if the lessee cannot make this initial processing payment the lease is denied. And, in a step 108, the seller who has guaranteed a lessee must now find another lessee and step 106 is repeated. It should be noted that although this is termed a processing payment, the payment may be any type of payment within the range which serves to further test the commitment of the lessee to fulfill the obligations of the lease.

As part of the screening process, in a preferred embodiment, it has been observed that requiring the lessee to obtain a contract for hauling freight reduces the likelihood of default, at least in the short run. This is a function of the fact that in the short run income will most likely be earned.

If in fact the lessee makes this initial payment and shows proof of a hauling contract, then the buyer leases the truck to lessee in a step 110 at time t₂. The lessee is required to make periodic payments as known in the lease art. In a preferred embodiment, these payments are weekly. The inventors have determined that the smaller the respective amount to be paid, even if at a higher frequency, reduces the likelihood of default. This also has the affect of reducing the effect of the interest rate on the total payment over the life of the lease as the lessee is prepaying principle and interest as compared to the prior art lease methods in which the periodic lump sums are due monthly.

If the lessee makes periodic payments at t₃ in a step 112, then the lease will proceed to completion in a step 118. Step 112 is repeated until the lease ends at t₄ in a step 118. If the lessee does not make the periodic payments, then they become in default of the lease in a step 114.

If in fact the lease is in default in a step 114, and the default cannot be cured, then in a step 116, the truck is repossessed. In order to facilitate repossession of the truck, each leased truck is provided with a GPS system so that the location of the truck may be tracked as known in the art. In this way, the location of the vehicle is known, and a repossession team may be quickly dispatched from the local area. In a preferred embodiment, a kill switch may be installed in each truck so that the truck may be disabled remotely to prevent further movement of the truck after default. In this way, time is not lost in repossession and releasing of the truck. The knowledge of such tracking and the certainty of loss of the vehicle in real time, further incentivizes the lessee to prevent default of the lease as the truck is the lessee's main source of income; further diminishing the risk of default on the lease.

Upon repossession or simultaneously therewith, the seller is notified and in a step 108 the seller finds another lessee which is qualified in accordance with the questionnaire and the initial finance payment and the process is repeated.

In a preferred embodiment, the lease is a commercial operating lease. Because it is a commercial operating lease in which there are not even implicit rights of ownership or even an option to purchase with an implicit right of ownership or an exercise of right of ownership, the buyer can take immediate possession of the truck upon default or at the end of the lease in a step 118. Therefore, in a step 120 the lessee relinquishes possession of the truck to the buyer. This does not mean that at the end of the lease the buyer cannot make an offer for the truck, which may or may not be accepted by the buyer, but the buyer is not obligated to sell the truck to the lessee.

As discussed above, the cost to the lessee is a function of the initial value of the truck at the beginning of the lease and the value of the truck at the end of the lease, among other things. Therefore, to further reduce the risk of default on the lease in a preferred embodiment, steps are taken to reduce the initial value of the vehicle, without forsaking quality of vehicle, which in turn reduces the value of the truck at the end of the lease. Accordingly, in a preferred embodiment, the trucks to be purchased are used trucks being about 1-5 years old and preferably 1-4 years old. The truck should have no more than approximately 500,000 miles on it as this is the midlife of most class 8 trucks. It is also preferable that the truck to be purchased be priced at or below wholesale.

Furthermore, to ensure that the quality is not diminished, the seller is required to certify the truck as meeting certain standards including receipt of the Department of Transportation certification, that each truck will have at least a 30-day/10,000 mile power train warranty and that each truck should receive an extensive mechanical and appearance point check to make sure that all systems are operating at or above minimum standards.

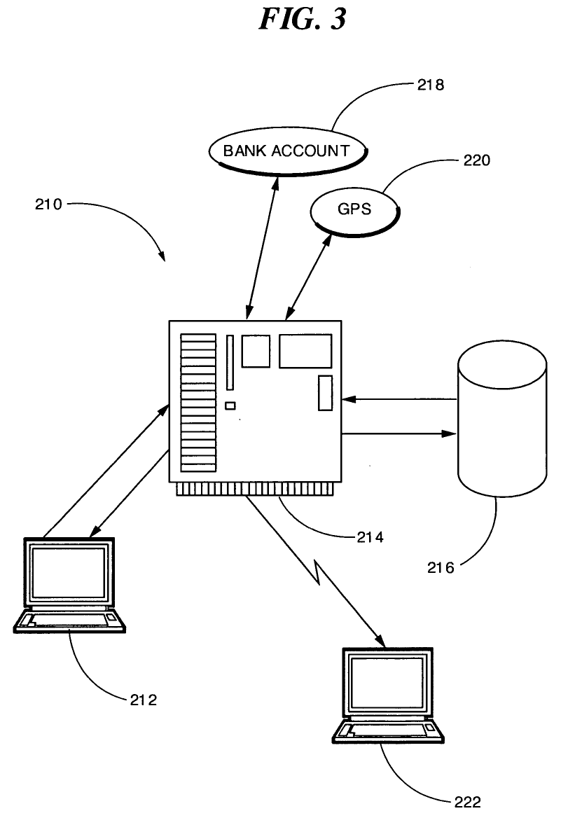

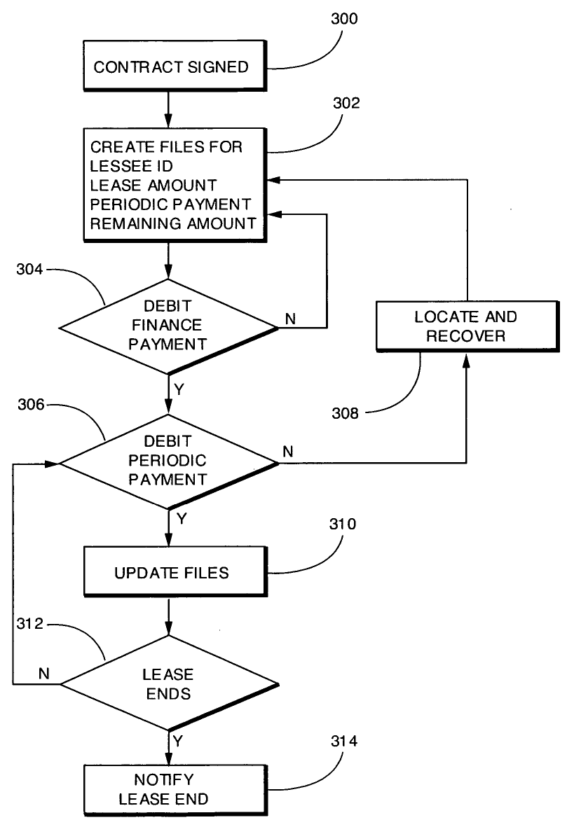

In a preferred embodiment, reference is now made to FIG. 3 in which a system for automatically performing the process of FIG. 4 is provided. A system 210 for automatically performing the method includes a server 214 operatively coupled to a database 216. The input and output of information to server 214 occurs through a computer 212. Server 214 is also coupled via known communication pathways, such as Internet, radio frequency or telephone, by way of example, with a GPS tracking system 220 as known in the art. Additionally, server 214 can communicate with bank accounts 218 of the lessee to effectuate automatic wire transfer withdrawals from the lessee's bank account. As described above at to, a retailer owner owns the truck and at t₁ guarantees a lessee for that truck for a predetermined period of time. At t₂, the buyer executes the contract in a step 300 to purchase the truck. At the same time, the lessee leases the truck from the buyer. In a step 302, the owner utilizing input 212 such as a personal computer (PC) or laptop computer, a server 214 and a database 216, creates files for the identification of the lessee, the entire amount of the lease, the term of the lease, the periodic payment to be made, the guarantor of the lessee (the seller) and the amount remaining on the lease. The lessee identification would be information necessary to identify and locate the lessee as well as the bank account information to allow automatic withdrawals by the owner corresponding to the periodic payment.

Simultaneously at t₂, server 214 performs a wire transfer from bank account 218 of lessee to buyer's bank account for the processing fee. In a step 304, it is determined whether or not the lessee's bank account has been debited for the finance fee. If it has not, as a result of insufficient finds, then server notifies seller at a computer 2221′ that it must locate and obtain another lessee and the information is then stored in files in a step 302. Notification can be performed by Internet, telephone, pager or the like. If in fact the debit of the bank account has occurred, then in a step 306, it is determined whether the bank account has been debited by server 214 for the periodic lease payment. If it is determined that the account has in fact not been debited as a result of insufficient funds, then in a step 308 the vehicle is located and recovered and the process is begun again at 302 for a new lessee to be provided by the seller.

If in fact the periodic payment has been made in step 306, then in a step 310 the files are updated. The remaining amount due file is decreased. In a step 312, it is determined whether the lease period has expired. This can be done either by determining whether or not the remaining amount due is zero, by counting the number of lease payments made or by utilizing a clock operating on server 214. If it is determined that the lease has not ended in step 312, the process is then returned to step 306.

If the lease ends at t₅, then server 214 notifies the buyer at computer 212. The buyer then takes possession of the truck.

While there have been shown, described and pointed out novel features of the present invention as applied to preferred embodiments thereof, it will be understood that various omissions and substitutions and changes in the form of details of the disclosed invention may be made by those skilled in the art without departing from the spirit and scope of the invention. It is the intention, therefore, to be limited only as indicated by scope of the claims appended hereto. It is also to be understood that the following claims are intended to cover all of the generic and specific features of the invention herein described and all statements of the scope of the invention which is a matter of language might be said to fall therebetween. In particular, this invention should not be construed to be limited to the use of the specific Internet structures, specific screens or web pages, specific prompts or specific valuation methods as disclosed herein.

1. A method for reducing the risk of leasing a class 8 truck to an individual comprising the steps of:
a truck seller guarantees a lessee for the truck for a predetermined period;
a buyer buys the truck from seller;
the buyer leases the truck to a lessee.

2. The method of claim 1, wherein said lessee pays a nonrefundable processing fee payment to the buyer and the buyer leases the truck to the lessee upon receipt of the financial payment, and said seller obtains a second lessee if said lessee does not make the financing fee payment.

3. The method of claim 1, wherein said lessee makes periodic payments to said buyer and if said lessee defaults on said periodic payments, said seller obtains a second lessee for said buyer.

4. The method of claim 3, wherein said buyer equips said truck with GPS identification equipment.

5. The method of claim 1, wherein said periodic payments are weekly.

6. The method of claim 2, wherein processing fee is at least $3,900.

7. The method of claim 1, wherein said lease is a commercial operating lease.

8. The method of claim 1, said lessee obtains a contract for hauling cargo prior to buyer leasing the truck to lessee.

9. A method of reducing risk assumed by a lessor of a vehicle comprising the steps of:
storing at least one computer data file in a computer database reflecting the terms of a purchase of a class 8 truck from a seller and a lease of said class 8 truck to a lessee, said terms including at least a guarantee from said seller to a buyer to obtain a lessee for said truck for a predetermined period;
causing a server coupled to said database to debit a bank account of said lessee an amount for a non-refundable processing fee;
obligating said lessee to pay periodic lease payments;
causing a transfer of said period lease payment on a periodic basis from a bank account of said lessee to a bank account of said buyer;
updating said computer data files each time said bank account is debited;
determining if a default has occurred; and
said server notifying said seller to provide a second lessee if a default of the lease has occurred.

10. The method of claim 8, wherein said transfer of periodic lease payments occurs weekly.

11. The method of claim 9, wherein said lease is a commercial operating lease.

12. The-method of claim 1, wherein said lessee obtains a contract for hauling of cargo prior to buyer leasing the truck to lessee.
